(19) United States
(12) Patent Application Publication
(10) Pub. No.: US 2026/0036156 A1
(43) Pub. Date: Feb. 5, 2026

(54) WALLBOARD ANCHOR

(71) Applicant: THE HILLMAN GROUP, INC., Forest Park, OH (US)

(72) Inventor: Russell Robert FLOCKEN, Cincinnati, OH (US)

(21) Appl. No.: 18/794,274

(22) Filed: Aug. 5, 2024

(51) Int. Cl. F16B 13/00

(52) U.S. Cl. CPC F16B 13/002

(57) ABSTRACT

An anchor for wallboard installation includes an elongated anchor body including a driving end and a wall boring end. The anchor body has a main body portion running from the driving end toward the wall boring end, and at least one thread extending along regions of the main body portion. The anchor body includes an internal bore surrounded by a wall of the main body portion. The anchor body includes diametrically opposed first and second thinwall segments formed in the wall of the main body portion to facilitate axial split of the main body portion along lines of weakness created by the first and second thinwall segments.

### TECHNICAL FIELD

This application relates generally to wall anchors for drywall and other types of wallboard, and more particularly, to a wallboard penetrating anchor.

### BACKGROUND

A variety of types of wall anchors are known, including anchors that can be rotated into wallboard without pre-drilling a hole in the wallboard. For example, U.S. Patent Publication No. 2020/0173482, which is incorporated herein by reference, discloses a plastic wallboard anchor that includes an elongated anchor body including a driving end and a wall boring end. The anchor body has a main body portion running from the driving end toward the wall boring end. The wall boring end includes a plurality of axially cutting extending teeth. The anchor body includes an internal bore and diametrically opposed through slots to the bore to facilitate split of an end portion of the anchor body when the anchor is installed in a wall and a fastener is inserted for mounting an object. Other examples of anchors that utilize opposed through slots in the anchor body wall also exist.

Improvements in both the manufacturability and performance of such anchors is continually sought.

### SUMMARY

In one aspect, an anchor for wallboard installation includes an elongated anchor body including a driving end and a wall boring end. The anchor body has a main body portion running from the driving end toward the wall boring end, and at least one thread extending along regions of the main body portion. The anchor body includes an internal bore surrounded by a wall of the main body portion. The anchor body includes diametrically opposed first and second thinwall segments formed in the wall of the main body portion to facilitate axial split of the main body portion along lines of weakness created by the first and second thinwall segments.

The details of one or more embodiments are set forth in the accompanying drawings and the description below. Other features, objects, and advantages will be apparent from the description and drawings, and from the claims.

### BRIEF DESCRIPTION OF THE DRAWINGS

FIGS. 1-4 show perspective views of one embodiment of an anchor;

FIGS. 5A-5D show side elevations of the anchor;

FIGS. 6-7 show perspective views of the wall boring end of the anchor;

FIGS. 8-9 show cross-section views of the anchor;

FIG. 10 shows a cross-section view of the anchor;

FIG. 11 shows a side elevation of part of the anchor;

FIGS. 12-15 show perspective views of another embodiment of an anchor;

FIGS. 16A-16D show side elevations of the anchor;

FIGS. 17-18 show perspective views of the wall boring end of the anchor;

FIGS. 19-20 show cross-section views of the anchor;

Fig.21 shows a cross-section view of the anchor;

FIG. 22 shows a side elevation of part of the anchor; and

FIG. 23 shows a view of the anchor after being split by insertion of a threaded fastener.

### DETAILED DESCRIPTION

In the drawings and description of various anchor embodiments below, the term wallboard is generally used to refer to the most common wallboard such as drywall, but it is recognized that the anchor components could be suitable for any other friable wallboard material, such as dense corks or foams or other materials that can crumble. Accordingly, the term wallboard as used herein is intended to broadly encompass, for example, both typical drywall (aka plasterboard and gypsum board) and such other friable wallboard materials.

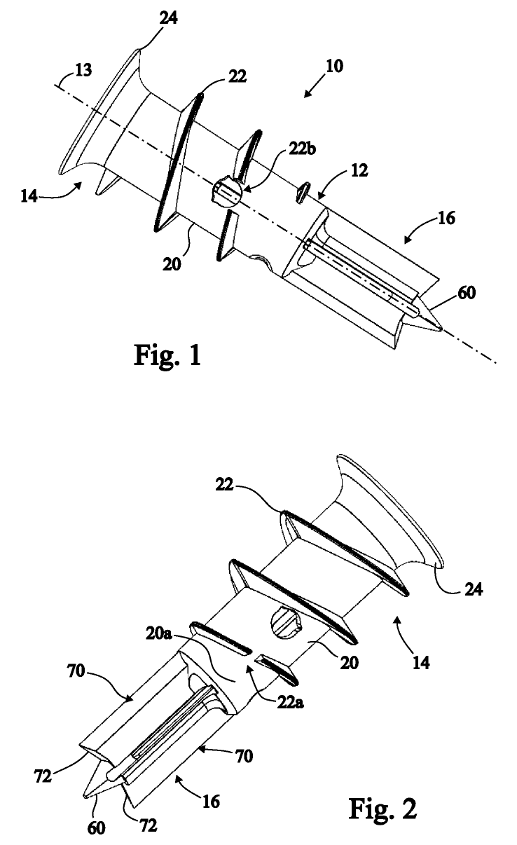

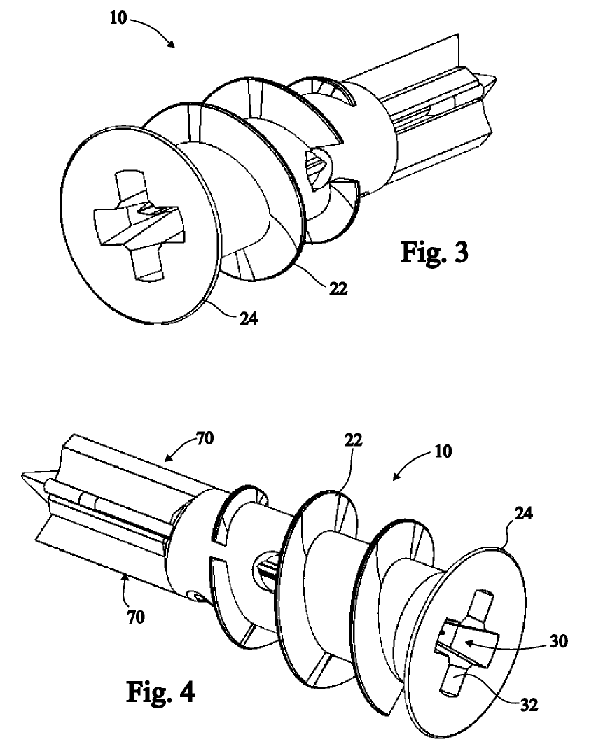

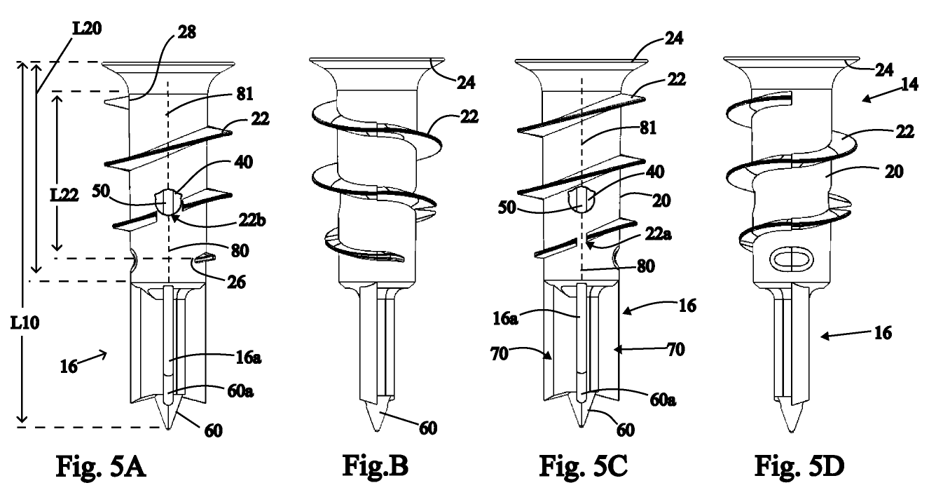

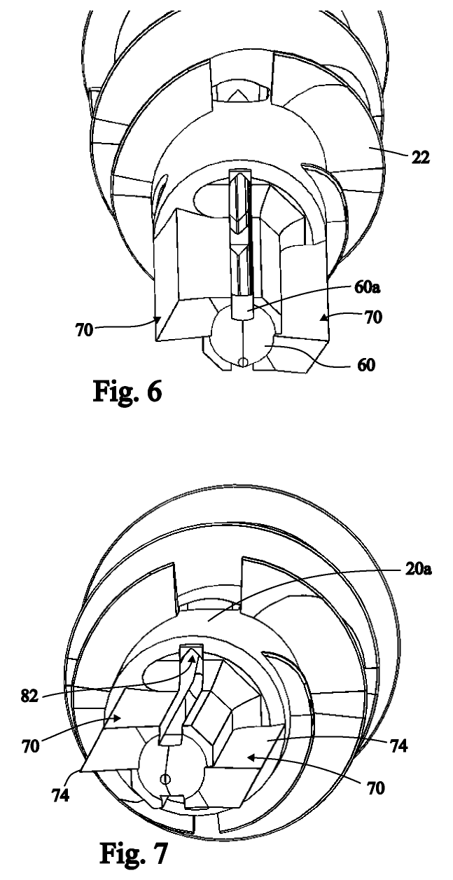

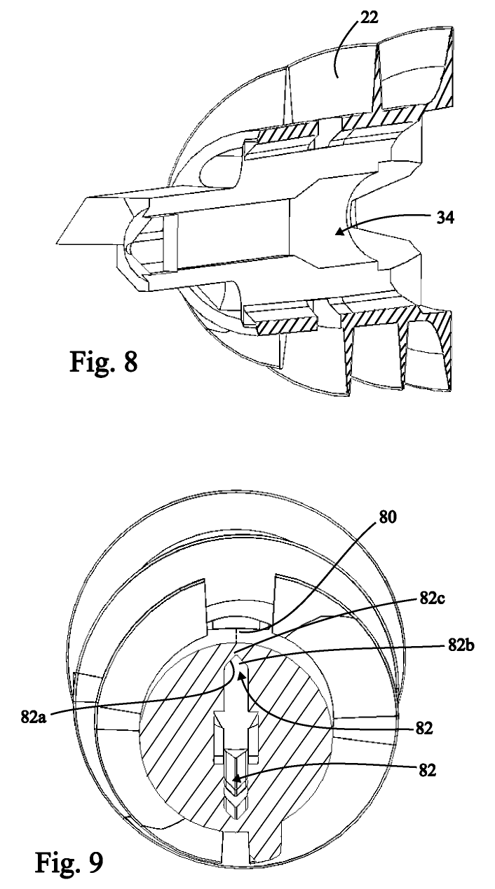

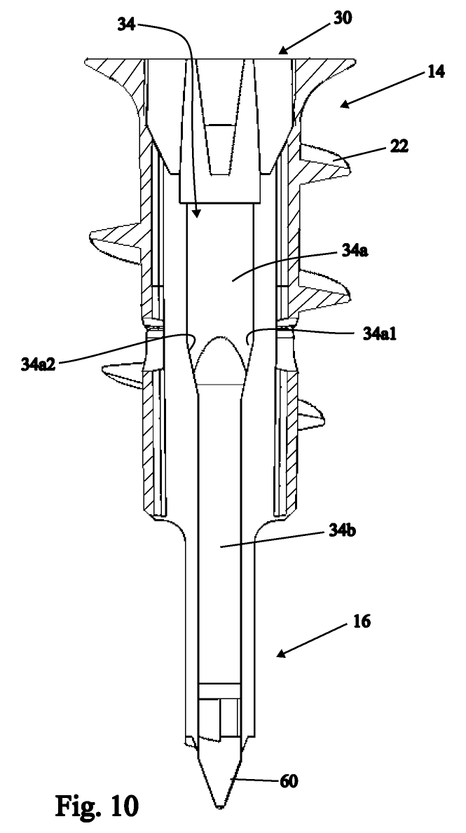

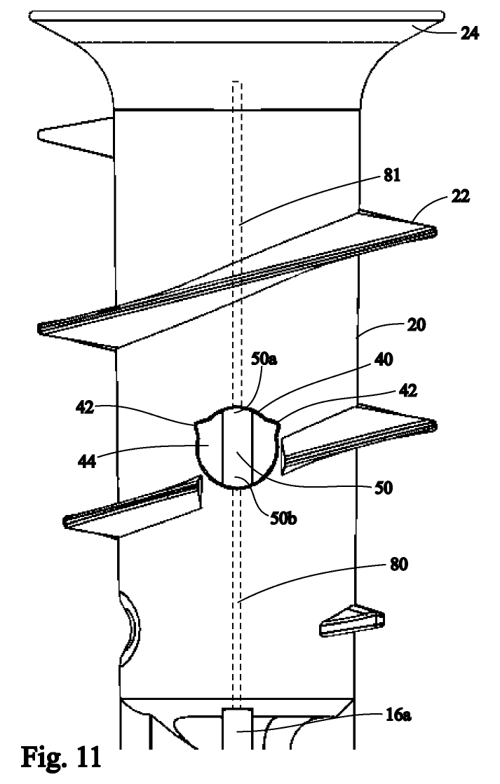

Referring to FIGS. 1-11, in one embodiment, an anchor 10 includes an elongated anchor body 12 with a lengthwise axis 13, and has a rearward driving end 14 and a forward or distal wall boring end 16. The anchor body may, for example, be formed of a molded plastic material, such as nylon. The driving end 14 of the body 12 includes a substantially cylindrical or slightly tapered main body portion 20 with a high thread 22 formed thereon. The high thread 22 will operate to engage with wallboard material to help retain the anchor body to a wall when installed. The high thread runs helically with a constant pitch and may have an axial length L22 that is between about 45% and about 55% of the full anchor length L10.

A flange 24 extends outward from the front rear end of main body portion 20 and will engage with the front surface of a wall to define the limit of penetration of the anchor. The underside of the flange 24 may be slightly tapered (e.g., slight frusto-conical shape) in order to push the outer surface of the wall inward slightly so that the face of the flange sits more flushly with the wall surface. The thread 22 begins at an axial location 26 along the body portion 20 and ends at a location 28 short of the flange 24. The end face of flange 24 defines an opening 30 into the cylindrical body 20 and includes an end portion defining a fastener driving recess 32 (e.g., a Phillips recess or some other configuration). Inward of the recess 32 an internal bore 34 of the cylindrical body 20 is provided for receiving a threaded fastener (e.g., a nut or bolt). An axial length L20 of the cylindrical body 20 may be between about 50% and about 70% of the anchor axial length L20 (such as between about 55% and about 65%).

It is recognized that the main body portion 20 need not be completely cylindrical along its full length. For example, the portion of main body portion 20 toward the wall boring end, or the full length of the main body portion 20, could include a small taper to reduce in diameter toward the wall boring end. Alternatively, there could be a slight step down in the diameter of the main body portion 20 toward the wall boring end (e.g., in the vicinity of the recesses 40 described below). Whether the body is completely cylindrical, partially cylindrical, fully or partially tapered, or included a slight step down in diameter, the term substantially cylindrical as used herein is considered to be applicable to the main body portion so long as a diameter of the main body portion at its forward end (toward the wall boring end of the anchor) is no less than eighty percent of a diameter of the main body portion at its rear end (proximate the flange 24).

Diametrically opposed recessed sections 40 are provided on the outer surface of the main body portion 20 in order to provide wall portions 44 of reduced thickness, and thus reduced strength. The perimeter of each recess 40 is curved for stress relief and may include small ear projection sections 42 on sides of the recess and facing toward the driving end of the anchor body. Diametrically opposed slots 50 are provided in the recessed sections 40, each slot including respective ends 50a and 50b in the wall portions 44 of the recessed sections 40 (e.g., end 50a is at one edge of the recessed section and end 50b is at another edge of the recessed section 40). The slots extend axially and completely through the wall of the main body portion 20 and into the internal bore 34 with a larger bore section 34A and a smaller bore section 34b in the end of the main body portion and along the wall boring end 16 of the anchor. The bore section 34b terminates in an end wall portion. Here, the positioning tip 60 has substantially conical configuration with recessed regions 60a to provide a zone of weakening to facilitate breakage of the positioning tip 60 during anchor split as is described further below.

Between the positioning tip 60 and the main body portion 20 a set of radially spaced apart and axially extending wallboard cutting teeth 70 are provided. In the illustrated embodiment, two teeth 70 are provided, but the number could vary. The anchor is configured to be driven into a wall by rotation in a clockwise direction as viewed axially from the driving end of the anchor. Each cutting tooth therefore includes a forward cutting edge 72 and a radial cutting edge 74. Notably, the forward cutting edge 72 extends radially outward and slightly forward (i.e., axially away from the driving end 14). The radial cutting edges 74 run substantially parallel to the anchor axis 13.

The anchor body 20 includes diametrically opposed thinwall segments 80 formed in the wall of the main body portion 20 to facilitate axial split of the main body portion 20 along lines of weakness created by the thinwall segments 80. The thinwall segments 80 are formed by diametrically opposed channels 82 that extend from the internal bore 34 radially outward into the wall of the main body portion 20. Notably, an outer surface 20a of the wall of the main body portion 20 is continuous across the thinwall segments, such that the presence of the thinwall segments is not visible when looking radially inward along the main body portion 20. Thus, the outer surface 20a is uninterrupted by the thinwall segments 80. Here, each thinwall segment 80 has an axial length that is at least ten times greater than its width (e.g., the length of each channel 82 is at least ten times greater than the width of the channel).

The thread includes a gap 22a in a region of one of the thinwall segments 80 to separate the thread 22 from the thinwall segment. The thread also includes an even larger gap 22b in the region of one of the recessed sections 40 to separate the thread from the recessed section.

Each channel 82 is formed by a pair of wall segments 82a, 82b that angle radially outward and toward each other such that a thinnest portion of the thinwall segment 80 is located at a region 82c where the wall segments 82a, 82b meet. The region 82c may be an angular intersection or a curved (e.g., radiused) intersection of the wall segments 82a, 82b.

The wall boring end 16 includes diametrically opposed through slots 16a, where one of the slots 16a is aligned with one of the thinwall segments 80 and the other slot 16a is aligned with the other thinwall segment 80. This configuration enhances anchor split. Each thinwall segment 80 runs from the wall boring end 16 axially to one of the recessed sections 40, and is aligned with the slot 50 in the recessed section 40 to further enhance anchor split.

Additional thinwall segments 81 may be provided running from the recessed sections 40 toward the flange end of the anchor (e.g., all the way to the fastener driving recess 32). These additional thinwall segments 81 (e.g., formed the same as thinwall segments 80) are aligned with the slots 50 and the thinwall segments 80, and may be primarily provided to facilitate anchor manufacture (e.g., by molding) rather than to try to effect split along the wall regions aligned with thinwall segments 81 (although in some case some split along the thinwall segments 81 may occur).

In terms of anchor install and split, as in the case of the anchor described in U.S. Patent Publication No. 2020/0173482, the anchor 10 is initially placed with its positioning tip against a wall and an axial force is applied. The axial force moves the tip into the wall sufficiently to bring the forward cutting edges of the cutting teeth adjacent the wall. Rotational torque is applied, along with continued axial force, to rotate the anchor entirely through the wall to achieve a set install position with flange 24 seated relatively flushly into the wall surface. Notably, the cutting teeth 70 cut a primary bore into the wall, with the bore slightly smaller in diameter than the main body portion, but large enough to allow user forces to move the main body portion 20 into the bore. Continued application of rotational and axial force engages the thread 22 into the wall, with the thread 22 cutting a thread path into the wall. In this position, the high thread 22 engages with the wallboard material and provides relatively solid retention against axial pull-out.

An object can be mounted to the anchor and wall using a threaded fastener, where the fastener passes through a hole in the object and then into the internal bore of the anchor. The fastener threadedly engages with internal wall sections (e.g., tapered wall sections 34a1, 34a2) of the bore 34 and is sized so that the force of the fastener against the wall sections causes an end segment of the anchor to split along the thin line segments 80. This split causes the portions of the anchor to expand outwardly, providing additional retention against wall pull out.

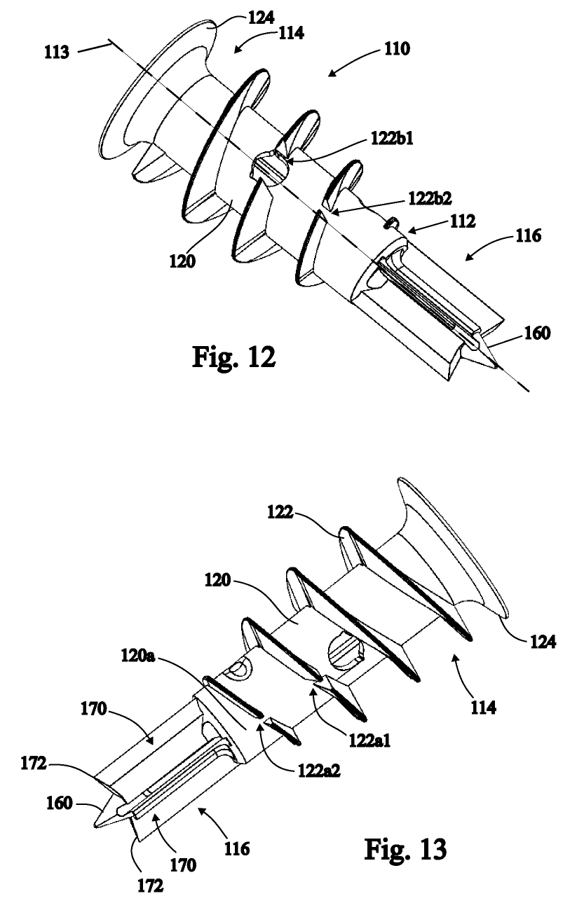

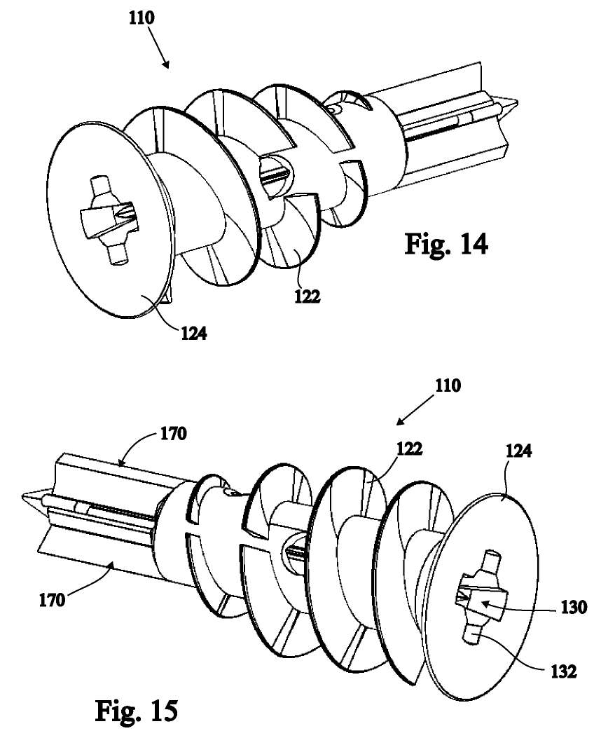

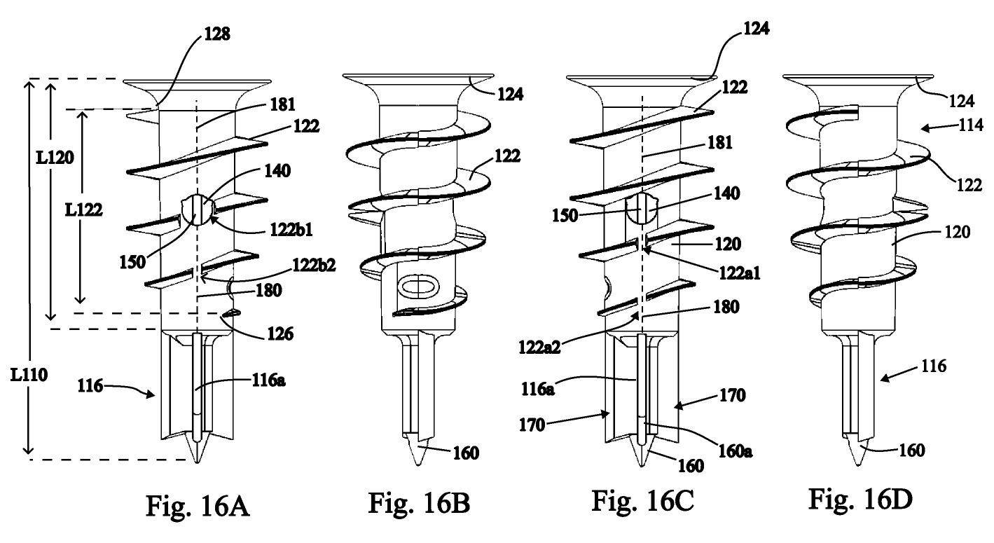

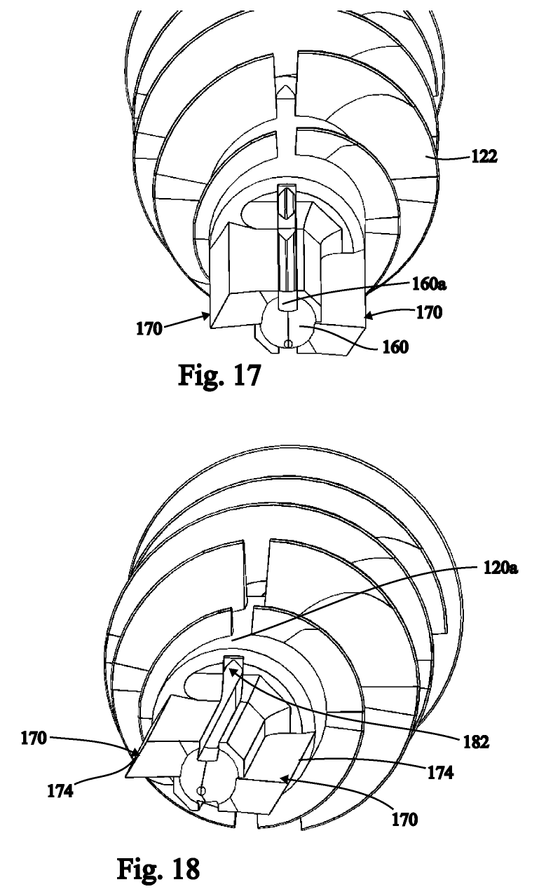

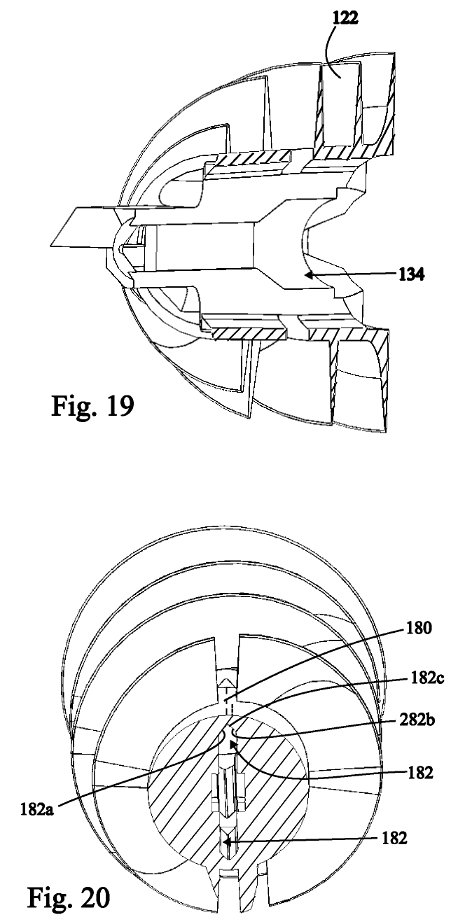

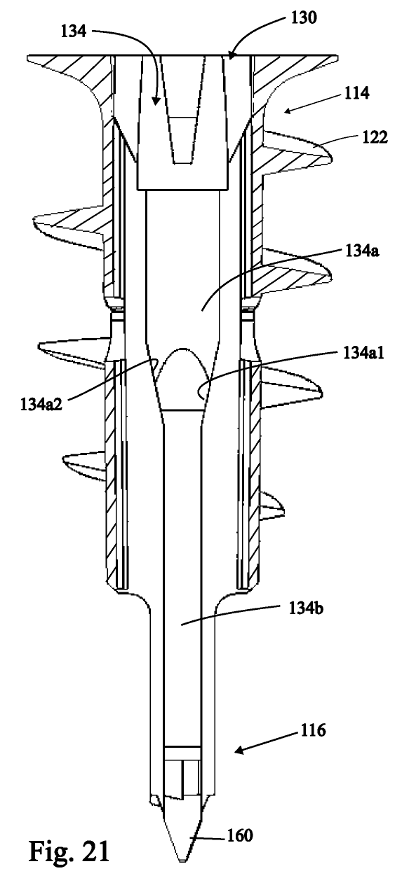

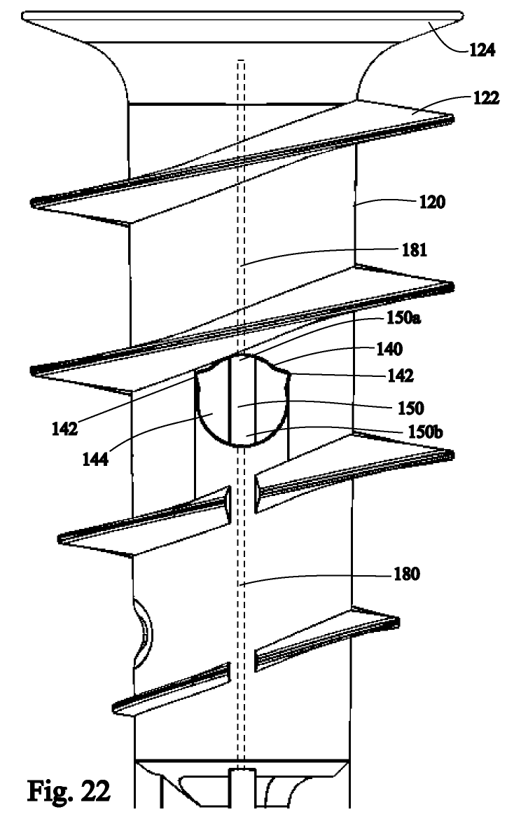

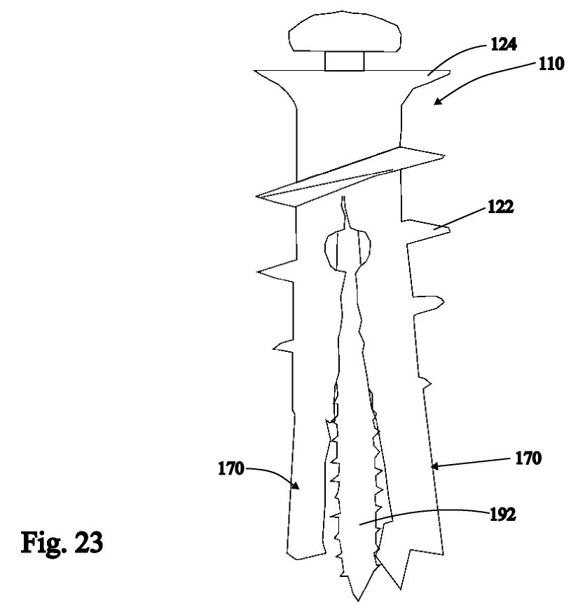

Referring to FIGS. 12-23, another embodiment of an anchor 110 includes an elongated anchor body 112 with a lengthwise axis 113, and has a rearward driving end 114 and a forward or distal wall boring end 116. The anchor body may, for example, be formed of a molded plastic material, such as nylon. The driving end 114 of the body 112 includes a substantially cylindrical or slightly tapered main body portion 120 with a high thread 122 formed thereon. The high thread 122 will operate to engage with wallboard material to help retain the anchor body to a wall when installed. The high thread runs helically with a constant pitch and may have an axial length L122 that is between about 45% and about 60% of the full anchor length L110.

A flange 124 extends outward from the front rear end of main body portion 120 and will engage with the front surface of a wall to define the limit of penetration of the anchor. The underside of the flange 124 may be slightly tapered (e.g., slight frusto-conical shape) in order to push the outer surface of the wall inward slightly so that the face of the flange sits more flushly with the wall surface. The thread 122 begins at an axial location 126 along the body portion 120 and ends at a location 128 short of the flange 124. The end face of flange 124 defines an opening 130 into the cylindrical body 120 and includes an end portion defining a fastener driving recess 132 (e.g., a Phillips recess or some other configuration). Inward of the recess 132 an internal bore 134 of the cylindrical body 120 is provided for receiving a threaded fastener (e.g., a nut or bolt). An axial length L120 of the cylindrical body 120 may be between about 55% and about 75% of the anchor axial length L120 (such as between about 60% and about 70%).

It is recognized that the main body portion 120 need not be completely cylindrical along its full length. For example, the portion of main body portion 120 toward the wall boring end, or the full length of the main body portion 120, could include a small taper to reduce in diameter toward the wall boring end. Alternatively, there could be a slight step down in the diameter of the main body portion 120 toward the wall boring end (e.g., in the vicinity of the recesses 140 described below). Whether the body is completely cylindrical, partially cylindrical, fully or partially tapered, or included a slight step down in diameter, the term substantially cylindrical as used herein is considered to be applicable to the main body portion so long as a diameter of the main body portion at its forward end (toward the wall boring end of the anchor) is no less than eighty percent of a diameter of the main body portion at its rear end (proximate the flange 24).

Diametrically opposed recessed sections 140 are provided on the outer surface of the main body portion 120 in order to provide wall portions 144 of reduced thickness, and thus reduced strength. The perimeter of each recess 140 is curved for stress relief and may include small ear projection sections 142 on sides of the recess and facing toward the driving end of the anchor body. Diametrically opposed slots 150 are provided in the recessed sections 140, each slot including respective ends 150a and 150b in the wall portions 144 of the recessed sections 140 (e.g., end 150a is at one edge of the recessed section and end 150b is at another edge of the recessed section 140). The slots extend axially and completely through the wall of the main body portion 120 and into the internal bore 134 with a larger bore section 134A and a smaller bore section 134b in the end of the main body portion and along the wall boring end 116 of the anchor. The bore section 134b terminates in an end wall portion. Here, the positioning tip 160 has substantially conical configuration with recessed regions 160a to provide a zone of weakening to facilitate breakage of the positioning tip 160 during anchor split as is described further below.

Between the positioning tip 160 and the main body portion 120 a set of radially spaced apart and axially extending wallboard cutting teeth 170 are provided. In the illustrated embodiment, two teeth 170 are provided, but the number could vary. The anchor is configured to be driven into a wall by rotation in a clockwise direction as viewed axially from the driving end of the anchor. Each cutting tooth therefore includes a forward cutting edge 172 and a radial cutting edge 174. Notably, the forward cutting edge 172 extends radially outward and slightly forward (i.e., axially away from the driving end 114). The radial cutting edges 174 run substantially parallel to the anchor axis 113.

The anchor body 120 includes diametrically opposed thinwall segments 80 formed in the wall of the main body portion 120 to facilitate axial split of the main body portion 120 along lines of weakness created by the thinwall segments 180. The thinwall segments 180 are formed by diametrically opposed channels 182 that extend from the internal bore 34 radially outward into the wall of the main body portion 120. Notably, an outer surface 120a of the wall of the main body portion 120 is continuous across the thinwall segments, such that the presence of the thinwall segments is not visible when looking radially inward along the main body portion 120. Thus, the outer surface 120a is uninterrupted by the thinwall segments 180.

The thread includes gaps 122a1, 122a2 in regions of one of the thinwall segments 180 to separate the thread 122 from the thinwall segment. The thread also includes an even large gap 122b1 in the region of one of the recessed sections 140 to separate the thread from the recessed section, along with a gap 122b2.

Each channel 182 is formed by a pair of wall segments 182a, 182b that angle radially outward and toward each other such that a thinnest portion of the thinwall segment 180 is located at a region 182c where the wall segments 182a, 182b meet. The region 182c may be an angular intersection or a curved (e.g., radiused) intersection of the wall segments 182a, 182b.

The wall boring end 116 includes diametrically opposed through slots 116a, where one of the slots 116a is aligned with one of the thinwall segments 180 and the other slot 116a is aligned with the other thinwall segment 80. This configuration enhances ancho split. Each thinwall segment 180 runs from the wall boring end 116 axially to one of the recessed sections 140, and is aligned with the slot 150 in the recessed section 140 to further enhance anchor split.

Additional thinwall segments 181 may be provided running from the recessed sections 140 toward the flange end of the anchor (e.g., all the way to the fastener driving recess 132). Thes additional thinwall segments 181 (e.g., formed the same as thinwall segments 180) are aligned with the slots 150 and the thinwall segments 180, and may be primarily provided to facilitate anchor manufacture (e.g., by molding) rather than to try to effect split along the wall regions aligned with thinwall segments 181 (although in some case some split along the thinwall segments 81 may occur).

In terms of anchor install and split, as in the case of the anchor described in U.S. Patent Publication No. 2020/0173482, the anchor 110 is initially placed with its positioning tip against a wall and an axial force is applied. The axial force moves the tip into the wall sufficiently to bring the forward cutting edges of the cutting teeth adjacent the wall. Rotational torque is applied, along with continued axial force, to rotate the anchor entirely through the wall to achieve a set install position with flange 124 seated relatively flushly into the wall surface. Notably, the cutting teeth 170 cut a primary bore into the wall, with the bore slightly smaller in diameter than the main body portion, but large enough to allow user forces to move the main body portion 120 into the bore. Continued application of rotational and axial force engages the thread 122 into the wall, with the thread 122 cutting a thread path into the wall. In this position, the high thread 122 engages with the wallboard material and provides relatively solid retention against axial pull-out.

An object can be mounted to the anchor and wall using a threaded fastener 192, where the fastener passes through a hole in the object and then into the internal bore of the anchor. The fastener threadedly engages with internal wall sections (e.g., tapered wall sections 134a1, 134a2) of the bore 134 and is sized so that the force of the fastener against the wall sections causes an end segment of the anchor to split along the thin line segments 180. This split causes the portions of the anchor to expand outwardly, providing additional retention against wall pull out.

It is to be clearly understood that the above description is intended by way of illustration and example only, is not intended to be taken by way of limitation, and that other changes and modifications are possible. Other configurations are also possible.

1. An anchor for wallboard installation, comprising:
an elongated anchor body including a driving end and a wall boring end;
wherein the anchor body has a main body portion running from the driving end toward the wall boring end, and at least one thread extending along regions of the main body portion;
wherein the anchor body includes an internal bore surrounded by a wall of the main body portion, wherein the anchor body includes diametrically opposed first and second thinwall segments formed in the wall of the main body portion to facilitate axial split of the main body portion along lines of weakness created by the first and second thinwall segments.

2. The anchor of claim 1, wherein the first and second thinwall segments are formed by diametrically opposed first and second channels that extend from the internal bore outward into the wall of the main body portion.

3. The anchor of claim 2, wherein an outer surface of the wall of the main body portion is continuous across the first and second thinwall segments.

4. The anchor of claim 2, wherein the wall of the main body portion has an outer surface that is uninterrupted by the first and second thinwall segments.

5. The anchor of claim 2, wherein the thread includes a first gap in a region of the first thinwall segment to separate the thread from the thinwall segment.

6. The anchor of claim 1, wherein each thin wall segment has an axial length and a width, wherein the axial length is at least ten times greater than the width.

7. The anchor of claim 2, wherein the first channel is formed by a pair of first wall segments that angle radially outward and toward each other such that a thinnest portion of the first thinwall segment is located at a first region where the first wall segments meet, wherein the second channel is formed by a pair of second wall segments that angle radially outward and toward each other such that a thinnest portion of the second thinwall segment is located at a second region where the second wall segments meet.

8. The anchor of claim 2, wherein the wall boring end includes a distal positioning tip and a set of spaced apart and axially extending wallboard cutting teeth, and diametrically opposed first and second through slots, wherein the first through slot is aligned with the first thinwall segment and the second through slot is aligned with the second thinwall segment.

9. The anchor of claim 8, wherein the set of spaced apart and axially extending wall board cutting teeth consists of diametrically opposed first and second wallboard cutting teeth.

10. The anchor of claim 2, wherein the main body portion further includes diametrically opposed first and second recessed sections in an outer surface of the main body portion, the first thinwall segment runs from the wall boring end axially to the first recessed section, and the second thinwall segment runs from the wall boring end axially to the second recessed section.

11. The anchor body of claim 10, wherein the first recessed section includes a first axial slot that aligns with the first thinwall segment, wherein the second recessed section includes a second axial slot that aligns with the second thinwall segment.
